(19) United States
(12) Patent Application Publication
(10) Pub. No.: US 2008/0177649 A1
(43) Pub. Date: Jul. 24, 2008

(54) SURPLUS PAYMENT COLLECTION SYSTEM AND METHOD

(75) Inventor: Chaun Heywood, Omaha, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/625,938

(22) Filed: Jan. 23, 2007

(51) Int. Cl. G06Q 40/00

(52) U.S. Cl. 705/35

(57) ABSTRACT

Surplus payments are added to credit card and other retail transactions. The surplus payments are handled by surplus payment server within a credit card processing system. A cardholder may select a surplus payment amount to be added to each transaction, the account to which surplus payments are to be deposited, and a maximum amount (e.g., monthly) that the surplus payments are not to exceed.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

Many people find it difficult to regularly save for retirement and other future needs. Some people are successful at saving when done as part of a regular payroll deduction, such as through a 401(k) or similar retirement plan. However, those plans typically have limits on how much can be deducted during each pay period. Furthermore, they are ill suited for non-retirement savings, such as for a down payment on a home, purchase of a car, emergency medical costs, and so forth.

Proposals have been made for consumers to save in easy, convenient ways apart from payroll deductions. For example, in U.S. Pat. No. 6,112,191, a system provides for a consumer to make an excess payment at the time of a sales transaction and have that excess payment credited to a savings or charitable account. The transaction may also be subject to a rounder amount, i.e., any transaction is rounded up to a pre-selected amount, resulting in a surplus payment from a checking or credit card account used for the transaction.

While such surplus payment systems can make it easy to save, they lack flexibility. For example, a consumer may want to add a fixed amount to every transaction (say, one dollar), without having amounts vary according to a rounding computation. Further, a consumer may want to have the feature of saving with each transaction, but in months where he or she has a large number of transactions (expected or not), the resulting large number of surplus payments may lead to financial hardship.

### BRIEF SUMMARY OF THE INVENTION

There is provided, in accordance with embodiments of the present invention, a network/system and method for posting surplus payments when a consumer conducts transaction. The surplus payments are transferred to a surplus payment account, and provide a savings plan for the consumer.

In one embodiment, a transaction processing network for processing sales transactions has a system for collecting surplus payments. The system includes a surplus payment database and a server. The database stores data representing (1) the amount of a surplus payment that is to be posted with each transaction, and (2) the maximum amount that is to be posted as surplus payments during a predetermined period of time. The server accesses the surplus payment database for (1) posting a surplus payment amount with a transaction amount, (2) transferring the posted surplus payment to a surplus account designated by the consumer, (3) maintaining a total of surplus payments posted during the predetermined period of time, and (4) when the total of surplus payments reach the maximum amount, taking an action such as ending the posting of surplus payments.

A more complete understanding of the present invention may be derived by referring to the detailed description of the invention and to the claims, when considered in connection with the Figures.

### BRIEF DESCRIPTION OF THE DRAWINGS

FIG. 1 is a block diagram illustrating a credit card network, in accordance with the present invention.

FIG. 2 illustrates in greater detail the acquirer system seen in FIG. 1.

FIG. 3 is a flow diagram illustrating the establishment of a surplus account used in the network of FIG. 1.

FIG. 4 is a flow diagram illustrating the operation of the credit card network of FIG. 1, where a surplus amount is added to a card transaction.

FIG. 5 illustrates a receipt printed at one of the POS devices seen in FIG. 1.

### DETAILED DESCRIPTION OF THE INVENTION

There are various embodiments and configurations for implementing the present invention. Generally, the embodiments provide systems and methods for posting/collecting a surplus payment when a consumer conducts a transaction. The surplus payment is selected in advance by the consumer, and is included in the total amount for each transaction (until changed by the consumer), so that the exact surplus payment for each transaction will be known in advance by the consumer.

The collection of the surplus payment is handled by a server located at a processing system or entity that handles transactions conducted at merchant locations. In one embodiment, the processing entity is an acquiring system of a credit or debit card network, which causes the surplus payment to be added to each credit card or debit card transaction authorized by the acquiring or processing system. The surplus payments during a statement period are accumulated and transferred to a surplus account at a financial institution that has been selected in advance by the account holder or cardholders The surplus account may be a savings account, brokerage account or other financial account selected by the cardholders As examples, the surplus account can be maintained for the benefit of the cardholder, for another person (such as a relative), or for a charity selected by the cardholders In some embodiments, several different consumers may direct that their surplus payments go to an account for a single entity or individual, such as a relative of those consumers, or be split or allocated among accounts for several entities or individuals.

Further, for preventing the collection of excessive surplus payments, the cardholder may select in advance a maximum cumulative amount that will be collected during a pre-established period of time (such as a monthly billing cycle or statement period of a credit card account). The cardholder is thus able to prevent financial hardship when the number of transactions during a period may be high, and when the collected surplus payments might otherwise exceed a total amount that can be comfortably budgeted by the cardholders

In some embodiments, accounts can be mixed, with the consumer using one account (e.g., credit card account) for a sales transaction, and directing the processing entity to deduct the surplus payment from a different account (e.g., a checking account).

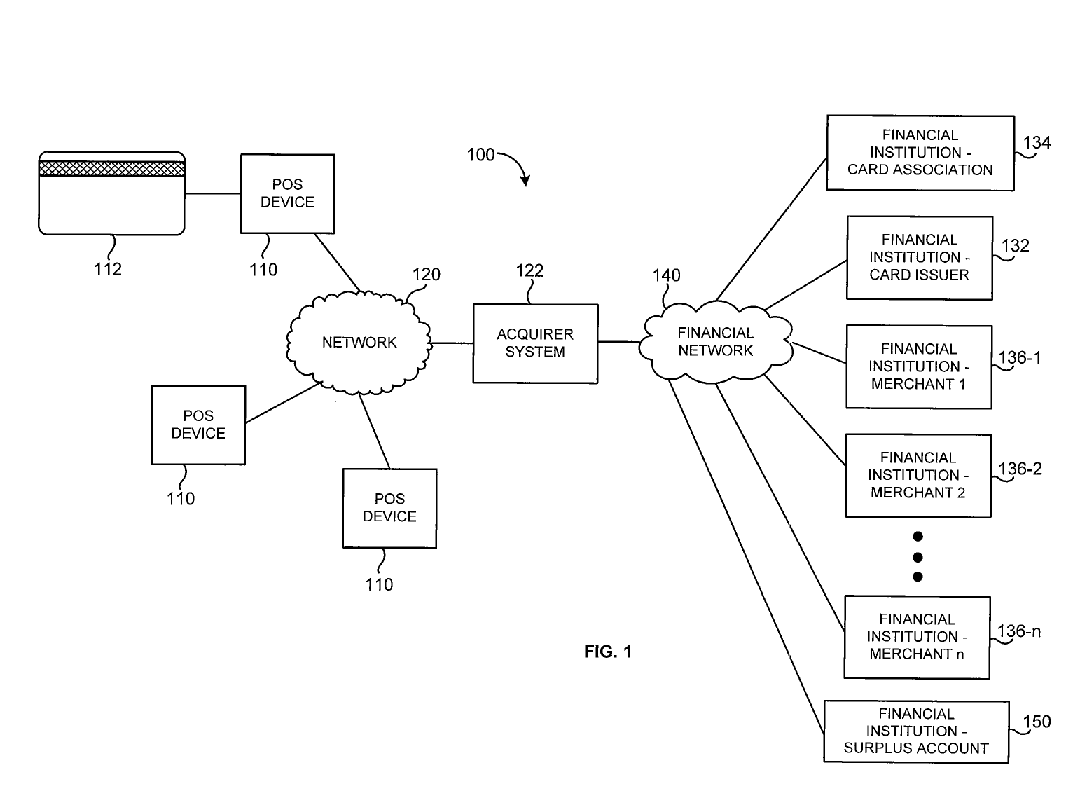

Referring now to FIG. 1, there is seen a credit card network 100 for processing payments made by a consumer using a credit card 112 at one of plural POS terminals or devices 1 10. The credit card 112 may have a magnetic stripe with encoded credit card ID information (e.g., credit card account number), which may be read at a card reader located at the POS device.

The POS devices 110 are connected through a retail network 120 to an acquirer system 122. The network 120 may represent, as examples, a network maintained in a single store having a number of POS devices, a central network linking a chain of stores that each have one or more POS devices 110, or a private or public network connecting POS devices at different merchant stores and different merchant chains. The acquirer system 122 processes and authorizes credit card transaction (as well as debit card and similar transactions) conducted at the POS devices 1 10. Acquirer systems are well known, and include those operated by credit card processing entities, such as First Data Corporation, Greenwood Village, Colo. The processing entity reconciles accounts maintained for the merchants, for a card issuing entity (e.g., the bank issuing the card to the consumer), and for a card association (e.g., VISA®, MasterCard®, American Express®, etc.). Thus, as an example, when a credit card transaction is conducted at one of the POS terminals 110, the acquirer system 122 may periodically debit an account at a financial institution 132 maintained for the card issuer (in order to pay the merchant), credit an association fee to an account at a financial institution 134 maintained for the card association, and credit an account at one of the financial institutions 136-1 though 136-n that are maintained for merchants 1 through n (such merchants being those having transactions conducted at the POS devices 110).

Payments among the various accounts are made through a financial network 140, which may represent a banking network through which ACH transfers may be made electronically to the various accounts. It should be noted that while FIG. 1 illustrates different institutions maintaining accounts for the various parties involved, some or all of the parties may use the same bank or financial institution, and in such case transfers would be made internally among the accounts at that financial institution.

As further illustrated in FIG. 1, the network 100 may also include a financial institution 150 that maintains a surplus account into which surplus payments may be deposited (as will be described in greater detail below).

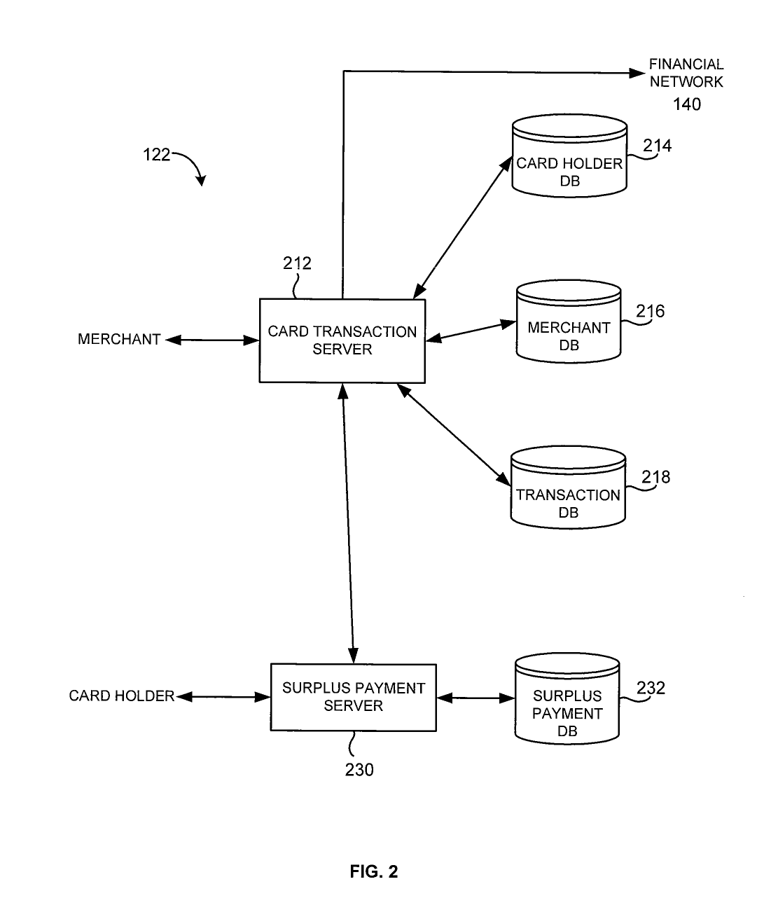

Referring now to FIG. 2, the acquirer system 122 is illustrated in greater detail. As seen, and as conventional, the acquirer system includes a card transaction server 212 which accesses several databases used in the handling of card transactions, including a cardholder database 214, a merchant database 216, and a transaction database 218. The cardholder database 214 stores information on each cardholder that has transactions processed by the processing entity, such as cardholder name, account number or ID, account balance, payment history and account features (interest rates, credit limits, statement start and end dates, and so forth). The merchant database 216 stores information on each merchant in the system, including merchant name and ID, merchant bank account (bank routing and account number), payment history, and so forth. The transaction database 218 stores information on individual transactions processed, including a transaction number, description of goods/services purchased, transaction amount, card account used, and so forth. When a credit card statement is to be sent to a cardholder, the transaction database is used by the server 212 to prepare the statement (or used to send transaction information to the card issuer for the issuer to prepare and send a statement to the cardholder). The server 212 also communicates through the financial network 140 to various financial institutions to credit/debit as appropriate the accounts of merchants, card issuers and card associations, in order to post transactions and payments.

In accordance with one embodiment, the acquirer system 122 also includes a surplus payment server 230 and associated surplus payment database 232. The surplus payment server 230 and database 232 manage surplus payments that are added to transactions for those cardholders that have requested a surplus payment feature for their accounts. As will be more fully described below, the cardholder communicates with server 230, e.g., via a website interface or via a telephone and interactive voice response (IVR) system, in order to request that surplus payments be collected with each transaction made using the cardholder's account. Among other things, the database 232 stores information on the amount of the surplus payment and the account to which surplus payments are to be posted.

While there are various way to implement a surplus payment feature, in one embodiment the cardholder database 214 will store an surplus payment indicator associated with each account, indicating whether or not the cardholder has elected to make surplus payments. When a transaction is conducted, server 212 checks database 214 for the indicator, and if it does show as “yes” (i.e., surplus payments have been elected), then the server 212 accesses the surplus payment database 232 through server 230 to find the amount of the surplus payment, and adds that to the transaction amount. The surplus payment database 232 also stores a running total of surplus payments, so that payments can be sent (e.g., daily, weekly, monthly) to the financial institution maintaining the account selected by the cardholder for receiving the surplus payments.

In another embodiment, there is no surplus payment indicator at the cardholder database 214. Rather, the transaction server 212 provides the account ID associated with each transaction to the surplus payment server 230, and database 232 is checked to see if a surplus payment has been selected for that cardholder (and if so, the surplus payment is added to the transaction amount).

In yet other embodiments, the transaction server 212 and surplus payment server 230 could in fact be one computer server, and the cardholder database 214 and surplus payment database 232 (as well as the other databases) could in fact be a single database system.

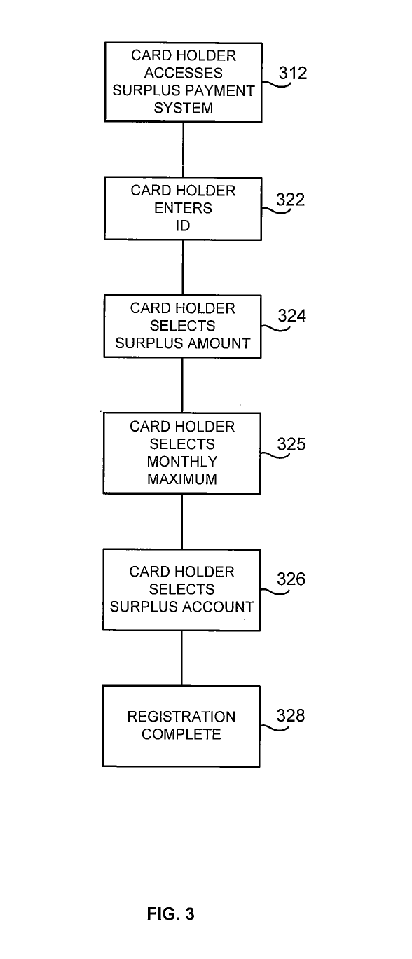

Referring now to FIG. 3, an exemplary process is illustrated for a cardholder to select a surplus payment feature for his/her account. The cardholder first accesses the surplus payment system or server 230 at step 312 (an account number is provided by the cardholder in order to obtain access). As mentioned earlier, the access can be by way of the internet with a web-based interface (website) or by telephone via an IVR system. Alternatively, telephone or in-person contact with a customer service representative could be used. Once the server 230 is accessed, the cardholder is asked to enter a PIN or ID at step 322 (for authentication), and the cardholder is asked for and enters the amount of the surplus payment that is to be applied to each transaction, step 324. As mentioned earlier, in order to avoid uncertainty, rather than using a rounded up amount, the system requires that the cardholder provide a specific fixed amount that is a to be added to each transaction. Such an amount could be specified as an amount in cents or dollars, or could be a percentage (e.g. 1% for each transaction). As will be explained later, selecting a specific amount for each transaction not only provides certainty as to how much the surplus payment will be for each transaction, but also permits the cardholder to foresee when surplus payments might become difficult to budget (when there are, for example, a large number of transactions during a single month or other billing cycle). Accordingly, at step 325, the cardholder provides a monthly maximum. At step 326, the cardholder selects the account into which surplus payment are to be deposited. Such account can be a savings, checking, brokerage or other account. The server 230 may provide a group of accounts from which a selection can be made (based on previously known account information pertaining to the cardholder), or set up a specific account (at an affiliated financial institution) for this purpose, or provide a field where the cardholder enters an account number (and other banking or routing information). At that point, the registration of the cardholder for purposes of activating the surplus payment feature is complete (step 328).

It should be appreciated that the selections chosen at steps 324, 325 and 326 can be changed by the cardholders After having previously made selections, the cardholder can at any time access the surplus payment server 230, proceeding through the same process as in FIG. 3 and changing previously made selections as desired.

While FIG. 3 contemplates that a surplus payment is taken from the same account (e.g., credit card account) that funds the sales transaction, it should be appreciated that the consumer could have surplus payments taken from a different account. Thus, as an example, for each credit card transaction, a cardholder could have surplus payments taken or withdrawn from a checking account or even from a different credit card account.

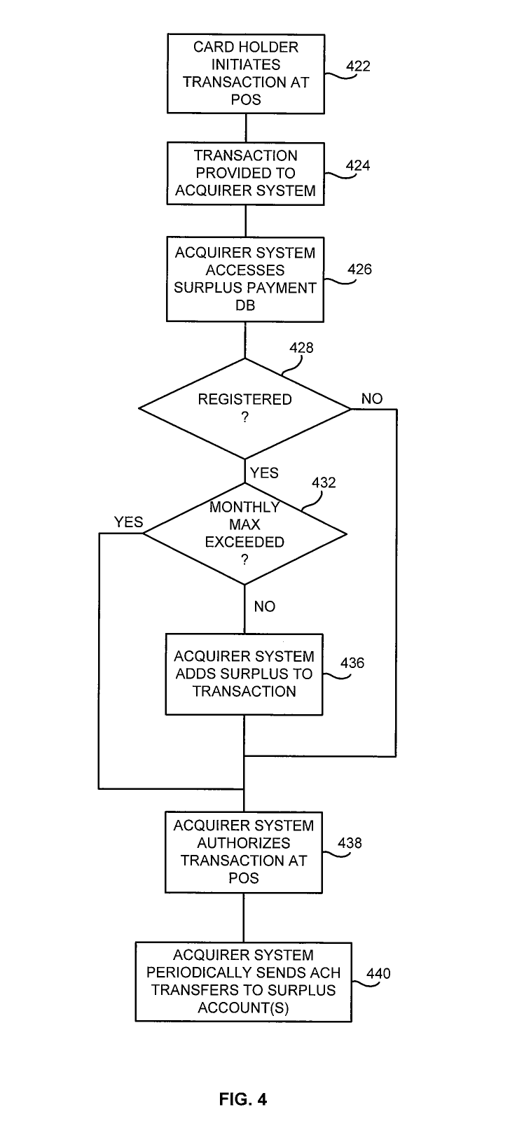

FIG. 4 illustrates an exemplary process when a cardholder conducts a transaction at one of the POS devices 110. At step 422, the cardholder initiates the transaction using a card at the POS device 110. Transaction data (transaction amount and account number) are provided to the acquirer system 122 (step 424). In the illustrated embodiment, the transaction server 212 accesses the surplus payment server 230 for a database look-up within database 232 to see if the surplus payment feature has been activated for that account (step 426). As mentioned earlier, in another embodiment, the cardholder database 214 could be accessed for that information.

If the cardholder is registered (a surplus payment feature has been activated for the account) at step 428, the server 230 checks to see if the surplus payments already posted for that month exceed the monthly maximum, step 432. If not, then the acquirer system adds the surplus payment to the transaction. The acquirer system then authorizes the transaction at the POS device (with the surplus payment) at step 438.

If the cardholder is not registered at step 432, or if the monthly maximum has been exceeded, then the acquirer system authorizes the transaction without the surplus payment at step 438.

In some embodiments, the server 230 may be programmed to provide a message (e.g., e-mail alert) to a cardholder when surplus payments reach or are near the maximum. Thus, for example, if a monthly maximum is $100, an alert is given when payments reach $90. The alert can be in addition to or in lieu of stopping further payments when a maximum is reached.

As also illustrated in FIG. 4, the acquirer system 122 may use the surplus payment server 230 to periodically transfer payments (e.g., ACH transfers) to the surplus payment account at the financial institution 150 maintaining that account (see FIG. 1). While not illustrated in FIG. 4, the acquirer system 122 may also provide periodic statements to the cardholder (e.g., as part of or separate from the cardholder's regular monthly statements) showing the number of surplus payments posted during the month. The surplus payment server 230 could maintain at database 232 records of surplus payments collected.

In some embodiments, several different cardholders or consumers may each have surplus payments added to their respective transactions, but have all those surplus payments going to a single account for one beneficiary (i.e., one common relative). In other embodiments, surplus payments from one or more consumers may be split or allocated among several accounts having different beneficiaries. In such instances, separate reports could be sent to both the cardholders and to beneficiaries.

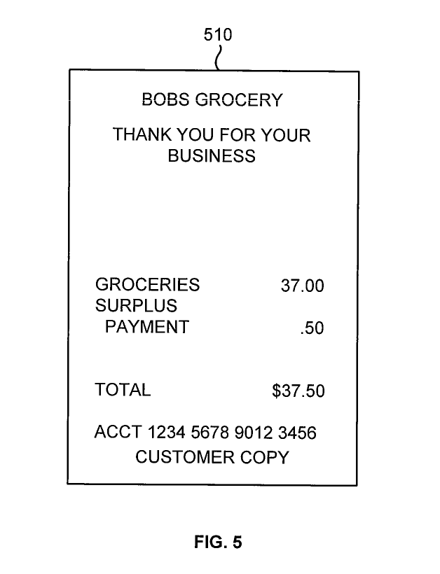

FIG. 5 illustrates a receipt 510 that could be printed and provided to the cardholder after a transaction has been authorized at the POS device 110. As seen, the receipt 510 not only shows the transaction amount (in this case, $37 for groceries), but also the surplus payment that is being posted to the credit card account with the transaction amount (in this case, the surplus payment is 50 cents, as pre-selected by the cardholder).

It can be seen from the preceding discussion that the present invention provides a novel method and system for posting surplus payments retail transactions. While detailed descriptions of presently preferred embodiments of the invention have been given above, various alternatives, modifications, and equivalents will be apparent to those skilled in the art without varying from the spirit of the invention. For example, while the disclosed embodiments provide for surplus payments to be added to credit card and debit card transactions, the invention has application to other forms of transaction payments (e.g., checking, stored value, gift card and other accounts). As other examples, while the described embodiments envision that the surplus payment is implemented by the acquirer system handling transaction processing for a merchant, in some instances the merchant may use a processing entity not having a surplus payment server and thus for that (or other reasons) transaction data could be provided directly by the merchant to the surplus payment server 230 (for authorizing a surplus payment) without first passing through an acquirer system. In addition, the surplus payment could be subject to a bonus amount (added to the consumer-selected surplus payment) as an incentive and paid by a merchant or financial institution (for example, the institution maintaining the surplus account). Many other additional features and modifications are possible. Therefore, the above description should not be taken as limiting the scope of the invention, which is defined by the appended claims.

What is claimed is:

1. In a transaction processing network for processing sales transactions, where transactions are conducted by a consumer at POS devices that collect data representing both a transaction amount and an account identifier identifying an account against which the transaction is to be posted, a system for collecting surplus payments, comprising:
a surplus payment database for storing, in association with the account identifier, data representing (1) the amount of a surplus payment that is to be posted with the transaction amount, and (2) the maximum amount that is to be posted as surplus payments during a predetermined period of time; and
a server that accesses the surplus payment database for (1) posting the surplus payment amount with the transaction amount, (2) transferring the posted surplus payment to a surplus account designated by the consumer, (3) maintaining a total of surplus payments posted during the predetermined period of time, and (4) when the total of surplus payments reach the maximum amount, thereafter ending the posting of surplus payments.

2. The system of claim 1, wherein the surplus payment is posted against the same account as the transaction amount.

3. The system of claim 2, wherein the transaction amount and the surplus payment are both posted against a credit card account.

4. The system of claim 1, wherein the surplus payment is posted against an account that is different than the account against which the transaction amount is posted.

5. The system of claim 4, wherein the transaction amount is posted against a credit card account and the surplus payment is posted against a checking account.

6. The system of claim 1, wherein the server is part of an acquiring system for processing credit and debit card transactions.

7. The system of claim 1, wherein the surplus payment database further stores an account identifier for a surplus payment account to which the surplus payment is to be transferred.

8. The system of claim 7, wherein the server uses an ACH transfer in order to electronically to transfer the surplus payment.

9. The system of claim 7, wherein surplus payments are transferred to a single surplus account by a plurality of consumers.

10. The system of claim 1, wherein the server prepares a periodic statement for the consumer identifying transactions during the statement period, and such statement further identifies surplus payments posted during the statement period.

11. The system of claim 1, wherein the pre-determined period of time is a credit card billing cycle.

12. In a system for an account holder to conduct sales transactions at POS devices, wherein the transactions are conducted using funds from a financial account identified by an account ID, wherein transaction data is passed from the POS devices to a processing network maintained by a processing entity that authorizes transactions, and wherein the transaction data passed to the processing network includes the amount of a transaction and the account ID, a method for collecting surplus payments as part of the transactions at the POS devices, the method comprising:
providing a surplus payment server at the processing entity;
storing in a database associated with the server (1) an account ID associated with each account holder that desires to have surplus payments collected, (2) a surplus payment that is to be collected in the same amount in each of plural transactions conducted by the account holder, (3) a surplus payment account identifier that identifies a surplus account to which surplus payments are transferred, and (4) a maximum cumulative amount of surplus payments to be collected during a pre-established period of time;
receiving transaction data at the processing entity when a transaction is being conducted at one of the POS devices;
providing the account ID included in the transaction data to the surplus payment server;
comparing at the server the provided account ID with account IDs stored at the database;
if there is a match of the provided account ID to a stored account ID, authorizing the transaction to be conducted at the processing network using funds from the financial account of the account holder, with the authorized transaction having the surplus payment added to the transaction amount unless the maximum amount has been exceeded; and
creating, at the surplus payment server, a record of each surplus payment so that the surplus payments to the surplus payment account.

13. The method of claim 12, wherein the surplus payment is authorized against the same account as the transaction amount.

14. The method of claim 12, wherein the transaction amount and the surplus payment are both authorized against a credit card account.

15. The method of claim 12, wherein the surplus payment is authorized against an account that is different than the account against which the transaction amount is authorized.

16. The method of claim 15, wherein the transaction amount is authorized against a credit card account and the surplus payment is authorized against a checking account.

17. The method of claim 12, wherein the server is part of an acquiring system for processing credit and debit card transactions.

18. The method of claim 17, wherein the server uses an ACH transfer in order to electronically to transfer the surplus payment.

19. The method of claim 17, wherein surplus payments are transferred to a single surplus account by a plurality of consumers.

20. The system of claim 12, wherein the server prepares a periodic statement for the consumer identifying authorized transactions during the statement period, and such statement further identifies surplus payment authorized during the statement period.

21. The system of claim 12, wherein the pre-determined period of time is a credit card billing cycle.

22. In a system for an account holder to conduct sales transactions at POS devices, where the transactions are conducted using funds from a financial account maintained for the account holder at a financial institution, where the financial account is identified by an account ID, and where the transaction data including the amount of the transaction and the account ID is passed from the POS devices to a processing network maintained by a processing entity that is separate from the financial institution and that authorizes sales transactions, a method for collecting surplus payments as part of the transactions at the POS devices, the method comprising:
providing a surplus payment server at the processing entity;
storing at the server (1) an account ID associated with an account holders that desire to have surplus payments collected, (2) a surplus payment that is to be collected in the same amount in each of plural transactions conducted by the account holder, (3) a surplus payment account identifier where surplus payments may be transferred; and (3) a threshold amount of surplus payments to be collected during a pre-established period of time;
receiving transaction data at the processing entity when a transaction is being conducted at one of the POS devices;
providing the account ID included in the transaction data to the surplus payment server;
comparing at the server the provided account ID with account IDs stored at the database;
if there is a match of provided account ID to a stored account ID, authorizing the transaction to be conducted at the processing network using funds from the financial account of the account holder, with the authorized transaction having the surplus payment added to the transaction;
communicating with the account holder if the threshold amount of surplus payments reached; and
creating, at the surplus payment server, a record of each surplus payment collected, so that the surplus payments may be credited to the surplus payment account.
